(19) United States
(12) Patent Application Publication
(10) Pub. No.: US 2015/0173018 A1
(43) Pub. Date: Jun. 18, 2015

(54) WIRELESS COMMUNICATION DEVICE, WIRELESS COMMUNICATION SYSTEM, WIRELESS COMMUNICATION METHOD, COMPUTER-READABLE MEDIUM, AND PERIPHERAL

(71) Applicant: CASIO COMPUTER CO., LTD., Tokyo (JP)

(72) Inventor: Takahiro TOMIDA, Hamura-shi, Tokyo (JP)

(73) Assignee: CASIO COMPUTER CO., LTD., Tokyo (JP)

(21) Appl. No.: 14/559,586

(22) Filed: Dec. 3, 2014

(30) Foreign Application Priority Data
Dec. 16, 2013 (JP) 2013-259416

(51) Int. Cl. H04W 52/02; H04W 4/00

(52) U.S. Cl. CPC H04W 52/0229; H04W 4/008

(57) ABSTRACT

An environment information measuring device changes a type of an advertisement to a type “ADV_IND” or a type “ADV_NONCONN_IND” based on a determination result as to whether a transmission condition is met, the transmission condition representing whether data transmission is required. Then, the environment information measuring device transmits the advertisement of the type after change to a communication terminal. The communication terminal controls the connection with the environment information measuring device based on the type of the advertisement received. The environment information measuring device does not transmit data such as temperature, relative humidity, and a WBGT value to the communication terminal, unless the environment information measuring device receives a connection request signal from the communication terminal.

### BACKGROUND

1. Technical Field

The present invention relates to a wireless communication device, a wireless communication system, a wireless communication method, a computer-readable medium, and a peripheral.

2. Related Art

A central, as a wireless communication device which performs wireless communication based on Bluetooth (registered trademark) low energy that is a short-range wireless communication standard, receives identification information called advertisement transmitted by a peripheral, as another wireless communication device, and transmits a connection request signal to the peripheral. Then, the central performs transmission and reception of data with the peripheral. In such a wireless communication device, power consumption has been suppressed during wireless communication with another wireless communication device (for example, see JP 2012-142877 A). The wireless communication device described in JP 2012-142877A learns a transmitting interval of the advertisement periodically transmitted by the peripheral. As a result, the wireless communication device determines a receiving interval of the advertisement and shortens one receiving operation time. Thus, wasteful power consumption is suppressed.

### SUMMARY

However, in the wireless communication device described in JP 2012-142877 A, when there is no information to update data in the peripheral (another wireless communication device), for example, even if there is no change in a measured value of a sensor included in the peripheral, the connection request signal is transmitted to the peripheral and the transmission and reception of the data with the peripheral are performed even though the data is not updated. Therefore, when the peripheral receives the connection request signal from the central being the communication partner, the peripheral transmits the data to the central even though the data is the same as the data previously transmitted. Therefore, the power has been consumed wastefully.

The present invention has been made in view of the above problem, and an object thereof is to provide a wireless communication device, a wireless communication system, a wireless communication method, a program, and a peripheral capable of suppressing wasteful power consumption.

In order to achieve the above object, a wireless communication device according to an embodiment of the present invention performs wireless communication with another wireless communication device and includes:
an identification information transmitting unit configured to transmit, to the another wireless communication device, identification information of any of a plurality of types of identification information;
a data acquiring unit configured to acquire data;
a determining unit configured to determine whether the data acquired by the data acquiring unit meets a transmission condition, the transmission condition representing whether data transmission to the another wireless communication device is required; and
an identification information type changing unit configured to change the type of the identification information transmitted by the identification information transmitting unit, based on a determination result of the determining unit.

According to an embodiment of the present invention, it is possible to suppress wasteful power consumption.

### BRIEF DESCRIPTION OF THE DRAWINGS

FIG. 1 is a view showing an exemplary configuration of a wireless communication system according to an embodiment of the present invention;

FIG. 2 is a diagram showing types of advertisements and explanation thereof;

FIG. 3 is a diagram showing an exemplary configuration of a communication terminal as an example of a wireless communication device according to the embodiment of the present invention;

FIG. 4 is diagram showing an exemplary configuration of an environment information measuring device as an example of the wireless communication device according to the embodiment of the present invention;

FIG. 5A is a diagram showing a WBGT value calculation table used when calculating a WBGT value;

FIG. 5B is a diagram showing a classification of the WBGT value;

FIG. 6 is a diagram for explaining the operation of the wireless communication system in FIG. 1;

FIG. 7 is a flowchart showing an example of communication processing executed by the communication terminal in FIG. 3;

FIG. 8 is a flowchart showing an example of advertisement transmission processing executed by the environment information measuring device in FIG. 4; and

FIG. 9 is a diagram showing an example of a transmission condition representing whether data transmission is required in a modified example.

### DETAILED DESCRIPTION

Hereinafter, an embodiment of the present invention will be described with reference to the drawings.

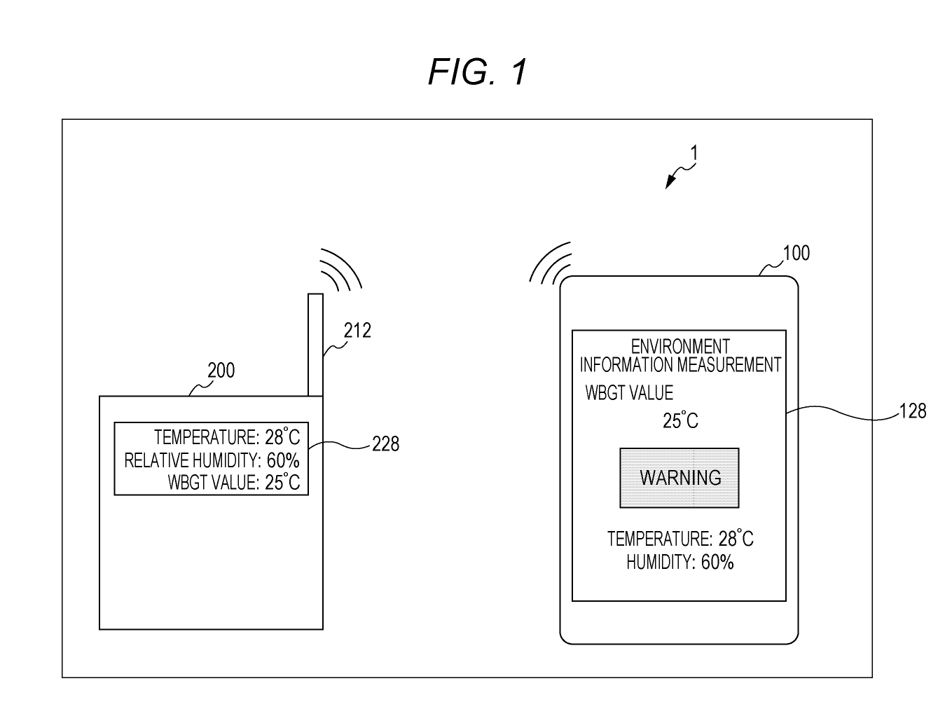

FIG. 1 is a view showing an exemplary configuration of a wireless communication system according to an embodiment of the present invention.

In the exemplary configuration shown in FIG. 1, the wireless communication system 1 includes a communication terminal 100 (a second wireless communication device) as a wireless communication device and an environment information measuring device 200 (a first wireless communication device) as a wireless communication device different from the communication terminal 100. The communication terminal 100 and the environment information measuring device 200 perform wireless communication with each other based on Bluetooth (registered trademark) low energy (hereinafter referred to as BLE). BLE is a standard (mode) designed to realize low power consumption in a short-range wireless communication standard called Bluetooth (registered trademark). There are the wireless communication device called central and the wireless communication device called peripheral, among wireless communication devices which perform wireless communication based on the BLE. The central is a device which uses service (for example, data measured) offered by the peripheral. The peripheral is a device which offers service (for example, data measured) to the central. In the present embodiment, the communication terminal 100 corresponds to the central and the environment information measuring device 200 corresponds to the peripheral.

The communication terminal 100 is a portable terminal having a wireless communication function based on the BLE, such as mobile phones, smartphones, tablet personal computers, and notebook personal computers. In the present embodiment, as an example, the communication terminal 100 includes a smartphone. The communication terminal 100 receives data such as temperature, relative humidity, and a Wet-Bulb-Globe temperature (WBGT) value from the environment information measuring device 200. Then, the communication terminal 100 displays various information on a display unit 128 described below as environment information, and outputs sound such as an alarm from a speaker 124 described below, based on the data received. A WBGT value is, for example, an index value which shows the degree to which a worker in a working environment is likely to suffer from heat stroke.

The environment information measuring device 200 is installed in a place where the temperature, the relative humidity, and the WBGT value are desired to be measured, such as a factory, a building site, a construction site, a gymnasium, and an athletic filed. The environment information measuring device 200 measures the temperature and the relative humidity of an installation place, and calculates the WBGT value from the measured values. Then, the environment information measuring device 200 transmits the data such as the temperature, the relative humidity, and the WBGT value to the communication terminal 100.

In the wireless communication performed based on the BLE, the peripheral transmits an advertisement and the central receives the advertisement, before transmission and reception of the data are performed between the central and the peripheral. The advertisement is identification information with which the peripheral informs the central of the presence of the peripheral, so that the central can search for the peripheral or the central can connect to the peripheral. The advertisement is sometimes referred to as “an advertise packet”, “an advertisement packet”, or “an advertising packet”. Transmitting the advertisement is referred to as “advertise” or “advertising”.

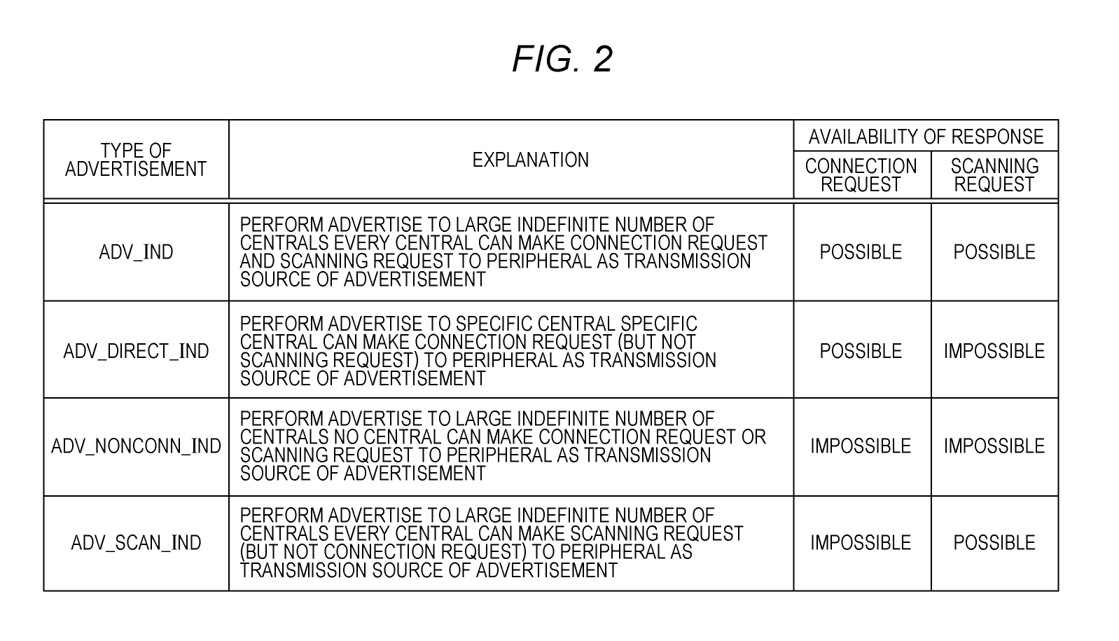

FIG. 2 is a diagram showing types, explanation, etc. of the advertisement used in advertise. As shown in FIG. 2, four types of the advertisements “ADV_IND”, “ADV_DIRECT_IND”, “ADV_NONCONN_IND”, and “ADV_SCAN_IND” are used in advertise. These types are identified by setting a value corresponding to each type in a type setting region (type region) provided in a header part of a packet configuration of the advertisement. For example, when the type is “ADV_IND”, “0x00” is set in the type setting region of the header part. When the type is “ADV_DIRECT_IND”, “0x01” is set in the type setting region of the header part. When the type is “ADV_SCAN_IND”, “0x02” is set in the type setting region of the header part. When the type is “ADV_NONCONN_IND”, “0x03” is set in the type setting region of the header part.

The type “ADV_IND” (also referred to as ADV_IND packet) indicates that the peripheral performs advertise to (broadcasts to) a large indefinite number of centrals, and every central can make a connection request and a scanning request (simple information inquiry) to the peripheral as a transmission source of the advertisement. The peripheral transmits its presence by informing a large indefinite number of the centrals of information such as its individual ID. In addition, the peripheral transmits the advertisement of the type “ADV_IND” when receiving (responding to) the connection request or the scanning request, if any, from the central. The scanning request is a request to the peripheral made by the central to know the device name of the peripheral, the service offered by the peripheral and the like before the central and the peripheral are connected.

The type “ADV_DIRECT_IND” (also referred to as ADV_DIRECT_IND packet) indicates that the peripheral performs advertise to the specific central, and the specific central can make the connection request to the peripheral as the transmission source of the advertisement. The peripheral transmits its presence by informing the specific central, to which the peripheral has connected before, of information such as its individual ID. In addition, the peripheral transmits the advertisement of the type “ADV_DIRECT_IND” when receiving (responding to) the connection request, if any, from the central. By using the advertisement of the type “ADV_DIRECT_IND”, it is possible to connect at high speed to the specific central to which the peripheral has connected before. The type “ADV_DIRECT_IND” is set so that the peripheral does not receive (respond to) the scanning request, if any, from the central.

The type “ADV_NONCONN_IND” (also referred to as ADV_NONCONN_IND packet) indicates that the peripheral performs advertise to a large indefinite number of the centrals, but no central can make the connection request or the scanning request to the peripheral as the transmission source of the advertisement. The peripheral transmits its presence by informing a large indefinite number of the centrals of information such as its individual ID. However, the peripheral transmits the advertisement of the type “ADV_NONCONN_IND” when not receiving (responding to) the connection request or the scanning request, if any, from the central.

The type “ADV_SCAN_IND” (also referred to as ADV_SCAN_IND packet) indicates that the peripheral performs advertise to a large indefinite number of the centrals, and every central can make the scanning request to the peripheral as the transmission source of the advertisement. The peripheral transmits its presence by informing a large indefinite number of the centrals of information such as its individual ID. In addition, the peripheral transmits the advertisement of the type “ADV_SCAN_IND” when receiving (responding to) the scanning request, if any, from the central. The type “ADV_SCAN_IND” is set so that the peripheral does not receive (respond to) the connection request, if any, from the central.

In the present embodiment, the environment information measuring device 200 as the peripheral transmits, to the communication terminal 100 as the central, the advertisement of the type “ADV_IND” (a first type) or the type “ADV_NONCONN_IND” (a second type) among the above four types. The environment information measuring device 200 may transmit, to the communication terminal 100, the advertisement of the type “ADV_DIRECT_IND” instead of the type “ADV_IND”, and may also transmit, to the communication terminal 100, the advertisement of the type “ADV_SCAN_IND” instead of the type “ADV_NONCONN_IND”. The environment information measuring device 200 may transmit, to the communication terminal 100, the advertisements of the above four types, and may also transmit, to the communication terminal 100, the advertisements of three types among the above four types.

The environment information measuring device 200 transmits the advertisement of the type “ADV_NONCONN_IND” when a transmission condition described below is not met. When the transmission condition described below is met, the advertisement of the type “ADV_IND” is transmitted. When the transmission condition is not met, that is, even when the connection with the communication terminal 100 is not necessary, the environment information measuring device 200 transmits the advertisement of the type “ADV_NONCONN_IND”. As a result, the communication terminal 100 which receives the advertisement can know, for example, whether the environment information measuring device 200 is in operation, and whether the environment information measuring device 200 is within a wireless wave coverage zone where the communication terminal 100 can be connected.

The communication terminal 100 as the central receives the advertisement transmitted by the environment information measuring device 200. At this time, the communication terminal 100 does not execute connecting operation processing with the environment information measuring device 200 when the type of the advertisement received is “ADV_NONCONN_IND”. The communication terminal 100 executes the connecting operation processing with the environment information measuring device 200 when the type of the advertisement is “ADV_IND”. The communication terminal 100 transmits/receives data to/from the environment information measuring device 200 after the communication terminal 100 executes the connecting operation processing with the environment information measuring device 200.

Next, a hardware configuration, etc. of the wireless communication system 1 according to the present embodiment will be described.

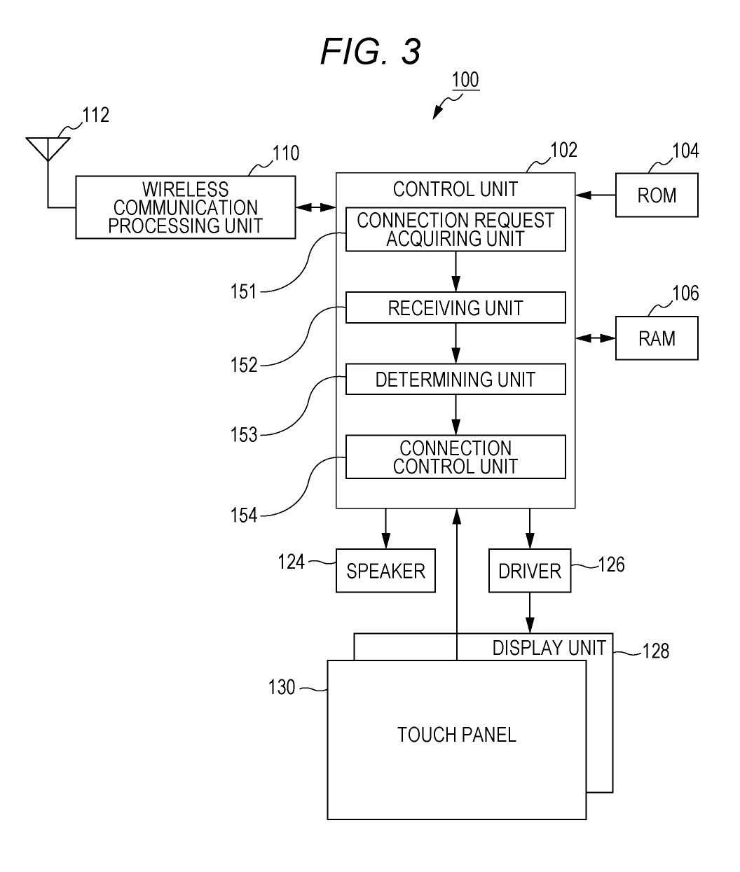

FIG. 3 is a block diagram schematically showing an exemplary configuration of the communication terminal 100 according to the present embodiment. As shown in FIG. 3, the communication terminal 100 includes a control unit 102, a read only memory (ROM) 104, a random access memory (RAM) 106, a wireless communication processing unit 110, an antenna 112, the speaker 124, a driver 126, the display unit 128, and a touch panel 130.

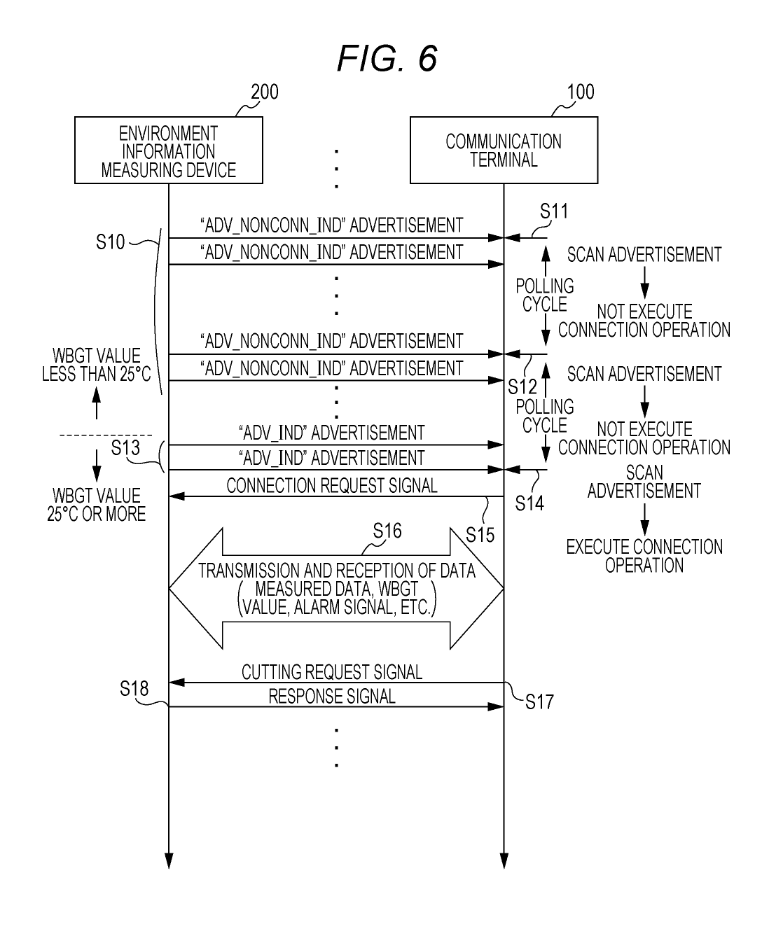

The control unit 102 includes, for example, a central processing unit (CPU). The control unit 102 controls various functions included in the communication terminal 100 by executing software processing according to a program (for example, a program for realizing operation of the communication terminal 100 described below and shown in FIG. 6) stored in the ROM 104.

The ROM 104 includes a non-volatile memory such as a flash memory, and stores the program or the data for the control unit 102 to control the various functions as described above. The RAM 106 includes a volatile memory, and is used as a work region to temporarily store the data so that the control unit 102 performs various processing.

The wireless communication processing unit 110 includes, for example, a wireless frequency (RF) circuit or a base band (BB) circuit. The wireless communication processing unit 110 transmits and receives a wireless signal based on the BLE via the antenna 112.

The speaker 124 outputs sound such as the alarm based on audio data from the control unit 102. The driver 126 outputs, to the display unit 128, an image signal based on image data output from the control unit 102. The display unit 128 includes, for example, a liquid crystal display (LCD) or an electroluminescence (EL) display. The display unit 128 displays an image (for example, the WBGT value and the image such as “warning” as shown in FIG. 1) according to the image signal output from the driver 126.

The touch panel 130 is arranged on an upper surface of the display unit 128 and is an interface used for inputting operation contents of a user. The touch panel 130 incorporates, for example, a transparent electrode not shown. When touched by a finger, etc. of the user, the touch panel 130 detects a position where the voltage has changed as a contact position, and outputs to the control unit 102 information of the contact position as an input instruction.

Next, a functional configuration of the control unit 102 of the communication terminal 100 will be described. As shown in FIG. 3, the control unit 102 functions as a connection request acquiring unit 151, a receiving unit 152, a determining unit 153, and a connection control unit 154.

After an application for measuring environment information is launched, the connection request acquiring unit 151 acquires, for example, an operation on the touch panel 130 performed by the user to measure environment information, as the connection request with the environment information measuring device 200. The connection request is not limited to the one generated by the operation of the user, and may be the one generated based on the passage of preset timer time after the application for measuring environment information is started.

The receiving unit 152 intermittently executes receiving operation processing to receive the advertisement in a preset polling cycle after the connection request acquiring unit 151 acquires the connection request. Receiving operation processing time may be set, for example, longer than a transmitting interval of the advertisement periodically transmitted by the environment information measuring device 200. The receiving unit 152 scans the advertisement in the receiving operation processing and receives the advertisement transmitted by the environment information measuring device 200.

The determining unit 153 determines whether the type of the advertisement received by the receiving unit 152 is “ADV_NONCONN_IND” or “ADV_IND”. Specifically, the determining unit 153 determines whether the value set in the type setting region in the header part of the advertisement is “0x03” corresponding to “ADV_NONCONN_IND” or “0x00” corresponding to “ADV_IND”.

The connection control unit 154 does not execute the connecting operation processing with the environment information measuring device 200 when it is determined by the determining unit 153 that the type of the advertisement is “ADV_NONCONN_IND”. The connection control unit 154 executes the connecting operation processing with the environment information measuring device 200 when it is determined by the determining unit 153 that the type of the advertisement is “ADV_IND”.

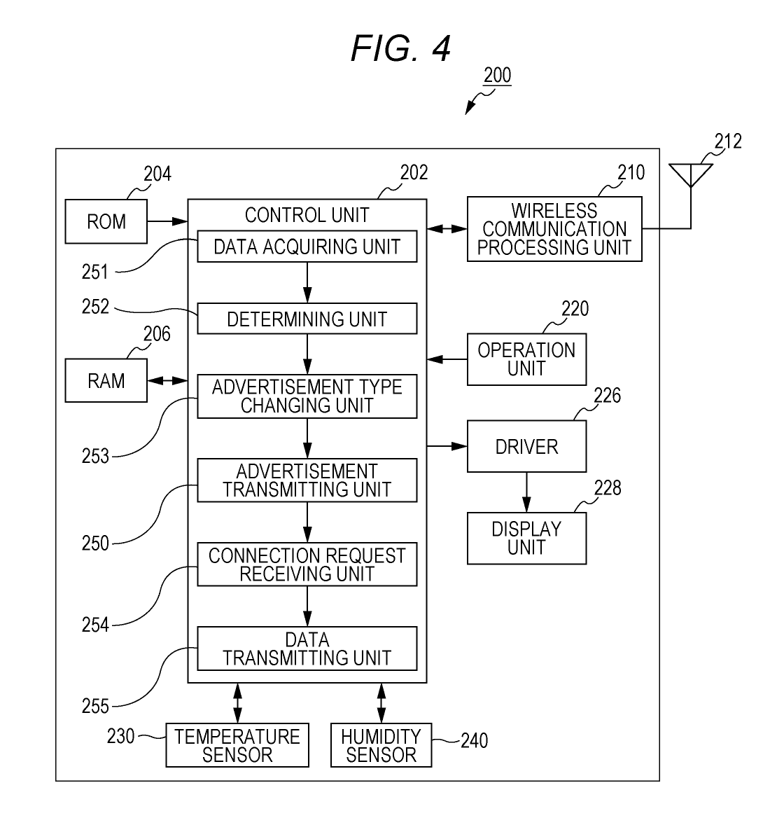

FIG. 4 is a block diagram schematically showing an exemplary configuration of the environment information measuring device 200 according to the present embodiment. As shown in FIG. 4, the environment information measuring device 200 includes a control unit 202, a ROM 204, a RAM 206, a wireless communication processing unit 210, an antenna 212, an operation unit 220, a driver 226, a display unit 228, a temperature sensor 230, and a humidity sensor 240.

The control unit 202 includes, for example, a CPU. The control unit 202 controls various functions included in the environment information measuring device 200 by executing software processing according to a program (for example, a program for realizing operation of the environment information measuring device 200 described below and shown in FIG. 6) stored in the ROM 204.

The ROM 204 includes a non-volatile memory such as a flash memory, and stores the program or data for the control unit 202 to control the various functions as described above. The RAM 206 includes a volatile memory, and is used as a work region to temporarily store the data so that the control unit 202 performs various processing.

The wireless communication processing unit 210 includes, for example, a wireless frequency (RF) circuit or a base band (BB) circuit. The wireless communication processing unit 210 transmits and receives a wireless signal based on the BLE via the antenna 212.

The operation unit 220 includes, for example, a switch, and is used for inputting operation contents of the user such as power on/off.

The driver 226 outputs, to the display unit 228, an image signal based on image data output from the control unit 202. The display unit 228 includes, for example, an LCD or an EL display. The display unit 228 displays an image (for example, the image representing a numeric value such as the temperature, the relative humidity, or the WBGT value as shown in FIG. 1) according to the image signal output from the driver 226.

The temperature sensor 230 includes, for example, a temperature measuring resistor or a thermocouple. The temperature sensor 230 measures a surrounding temperature of the environment information measuring device 200, that is, the temperature of the place where the environment information measuring device 200 has been installed, and transmits data indicating a measurement result to the control unit 202.

The humidity sensor 240 includes, for example, a polymer membrane. The humidity sensor 240 measures relative humidity around the environment information measuring device 200, that is, the relative humidity of the place where the environment information measuring device 200 has been installed, and transmits data indicating a measurement result to the control unit 202.

Next, a functional configuration of the control unit 202 of the environment information measuring device 200 will be described. As shown in FIG. 4, the control unit 202 functions as an advertisement transmitting unit 250, a data acquiring unit 251, a determining unit 252, an advertisement type changing unit 253, a connection request receiving unit 254, and a data transmitting unit 255.

The advertisement transmitting unit 250 periodically transmits the advertisement of the type “ADV_IND” or the type “ADV_NONCONN_IND” to the communication terminal 100 in a preset transmitting cycle.

The data acquiring unit 251 acquires the data indicating the measurement result of the temperature from the temperature sensor 230. In addition, the data acquiring unit 251 acquires the data indicating the measurement result of the relative humidity from the humidity sensor 240.

The determining unit 252 calculates the WBGT value from the data of the temperature and the relative humidity acquired by the data acquiring unit 251, and determines whether the WBGT value calculated meets the transmission condition, the transmission condition representing whether data transmission described below is required. In this embodiment, the determining unit 252 reads the WBGT value corresponding to the temperature and the relative humidity as a calculated result, and then determines whether the WBGT value read is equal to or more than a reference value, by referring to a WBGT value calculation table preliminarily stored and prepared in the ROM 204.

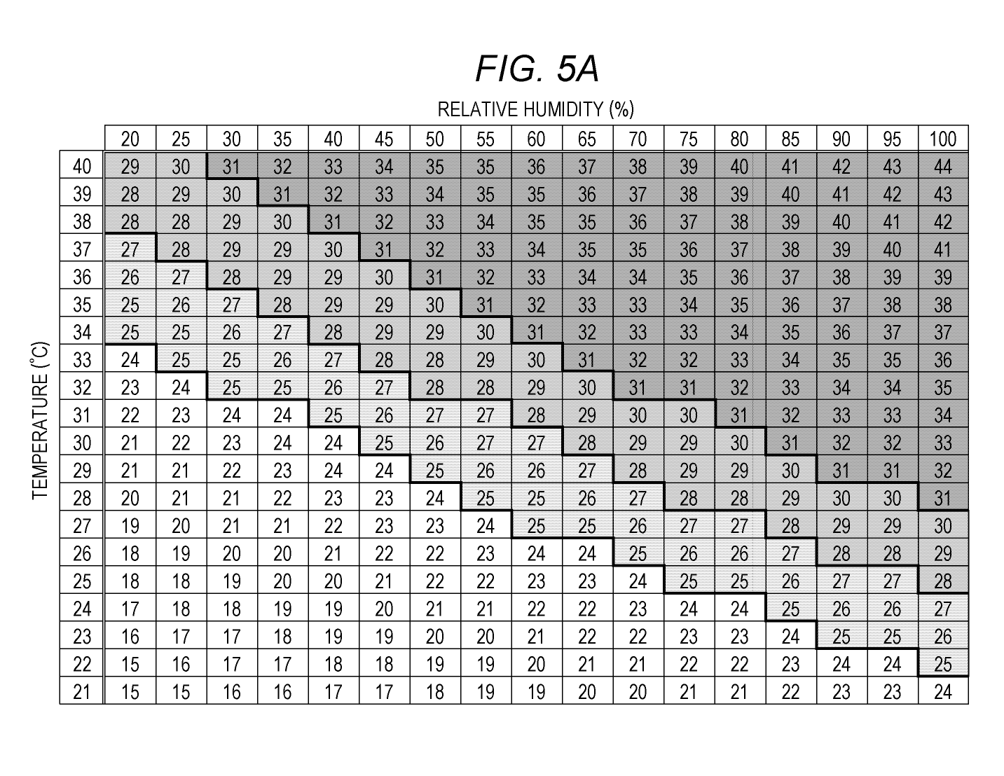

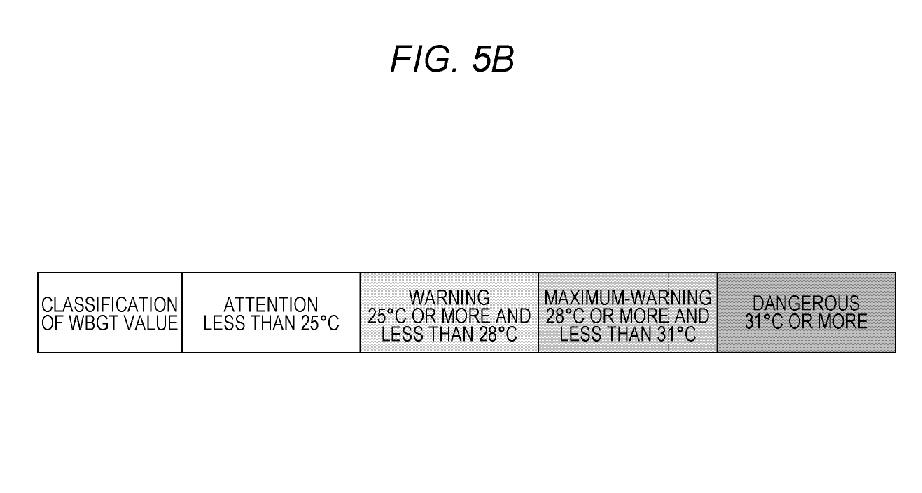

FIG. 5A is a diagram showing an example of the WBGT value calculation table used when calculating the WBGT value. In the WBGT value calculation table shown in FIG. 5A, the WBGT value has been set corresponding to the temperature and the relative humidity. For example, when the temperature is 25° C. and the relative humidity is 60%, the WBGT value is 23° C. When the temperature is 28° C. and the relative humidity is 60%, the WBGT value is 25° C. The WBGT value indicates that heat stroke is more likely to occur as the WBGT value rises. For example, the WBGT value is classified into four categories as shown in FIG. 5B, i.e., attention (less than 25° C.), warning (25° C. or more and less than 28° C.), maximum-warning (28° C. or more and less than 31° C.), and dangerous (31° C. or more), according to the degree of being likely to cause heat stroke.

In this embodiment, the reference value is set to 25° C. as an example. The determining unit 252 determines that the data transmission to the communication terminal 100 is required, that is, the transmission condition is met, when the WBGT value calculated is 25° C. or more. In addition, the determining unit 252 determines that the data transmission to the communication terminal 100 is not required, that is, the transmission condition is not met, when the WBGT value calculated is less than 25° C.

When it is determined by the determining unit 252 that the data transmission to the communication terminal 100 is not required, for example, in a state where the advertisement transmitting unit 250 has been transmitting the advertisement of the type “ADV_IND”, the advertisement type changing unit 253 changes the type of the advertisement transmitted by the advertisement transmitting unit 250 from the type “ADV_IND” to the type “ADV_NONCONN_IND” by setting the type setting region in the header part of the advertisement. When it is determined by the determining unit 252 that the data transmission to the communication terminal 100 is not required in a state where the advertisement transmitting unit 250 has been transmitting the advertisement of the type “ADV_NONCONN_IND”, the advertisement type changing unit 253 keeps the type of the advertisement transmitted by the advertisement transmitting unit 250 at the type “ADV_NONCONN_IND”.

When it is determined by the determining unit 252 that the data transmission to the communication terminal 100 is required, for example, in a state where the advertisement transmitting unit 250 has been transmitting the advertisement of the type “ADV_NONCONN_IND”, the advertisement type changing unit 253 changes the type of the advertisement transmitted by the advertisement transmitting unit 250 from the type “ADV_NONCONN_IND” to the type “ADV_IND” by setting the type setting region in the header part of the advertisement. When it is determined by the determining unit 252 that the data transmission to the communication terminal 100 is required in a state where the advertisement transmitting unit 250 has been transmitting the advertisement of the type “ADV_IND”, the advertisement type changing unit 253 keeps the type of the advertisement transmitted by the advertisement transmitting unit 250 at the type “ADV_IND”.

The connection request receiving unit 254 puts a connection request signal from the communication terminal 100 in a receivable state for a prescribed period after the advertisement transmitting unit 250 transmits the advertisement to the communication terminal 100, and receives the connection request signal from the communication terminal 100 in the receivable state.

The data transmitting unit 255 transmits, to the communication terminal 100, the data such as the temperature, the relative humidity, and the WBGT value acquired by the data acquiring unit 251 or an alarm signal, according to the connection request signal from the communication terminal 100 received by the connection request receiving unit 254.

Next, operation of the wireless communication system 1 according to the present embodiment will be described with reference to a flowchart in FIG. 6.

As shown in FIG. 6, the environment information measuring device 200 performs advertise (Step S10), i.e., periodically transmitting the advertisement of the type “ADV_NONCONN_IND” to the communication terminal 100. At each transmission time point of the advertisement in Step S10 shown in FIG. 6, the WBGT value calculated is less than 25° C., and the transmission condition is not met. Therefore, the type of the advertisement transmitted in Step S10 is “ADV_NONCONN_IND”.

The communication terminal 100 executes the receiving operation processing (Step S11) to receive the advertisement, for example, based on the operation on the touch panel 130 performed by the user to measure the environment information. In Step S11, the communication terminal 100 scans the advertisement and receives the advertisement transmitted by the environment information measuring device 200. The communication terminal 100 determines that the type of the advertisement received is “ADV_NONCONN_IND”. Therefore, the communication terminal 100 does not execute the connecting operation processing with the environment information measuring device 200.

The communication terminal 100 executes the receiving operation processing (Step S12) to receive the advertisement again after the polling cycle passes. Also in Step S12, the communication terminal 100 scans the advertisement, receives the advertisement transmitted by the environment information measuring device 200, and determines that the type of the advertisement received is “ADV_NONCONN_IND”. Therefore, the communication terminal 100 does not execute the connecting operation processing with the environment information measuring device 200.

Next, the environment information measuring device 200 performs advertise (Step S13), i.e., periodically transmitting the advertisement of the type “ADV_IND” to the communication terminal 100. At each transmission time point of the advertisement in Step S13, the WBGT value calculated by the environment information measuring device 200 is 25° C. or more, and the transmission condition is met. Therefore, the type of the advertisement transmitted in Step S13 is “ADV_IND”.

Next, the communication terminal 100 executes the receiving operation processing (Step S14) to receive the advertisement again after the polling cycle passes. In Step S14, the communication terminal 100 scans the advertisement and receives the advertisement transmitted by the environment information measuring device 200. The communication terminal 100 determines that the type of the advertisement received is “ADV_IND”. Therefore, the communication terminal 100 executes the connecting operation processing (Step S15) with the environment information measuring device 200. In Step S15, the communication terminal 100 transmits the connection request signal to the environment information measuring device 200. As a result, the environment information measuring device 200 and the communication terminal 100 are connected.

Next, upon receiving the connection request signal from the communication terminal 100, the environment information measuring device 200 cuts off advertise temporarily and transmits the data to the communication terminal 100. Then, the communication terminal 100 receives the data transmitted by the environment information measuring device 200. That is, the transmission and reception of the data are performed between the environment information measuring device 200 and the communication terminal 100 (Step S16). In Step S16, the environment information measuring device 200 transmits the data such as the temperature, the relative humidity, and the WBGT value, and the alarm signal to the communication terminal 100.

When the transmission and reception of the data between the environment information measuring device 200 and the communication terminal 100 are complete, the communication terminal 100 executes cutting operation processing (Step S17) with the environment information measuring device 200. In Step S17, the communication terminal 100 transmits a cutting request signal to the environment information measuring device 200. Then, upon receiving the cutting request signal from the communication terminal 100, the environment information measuring device 200 transmits a response signal to the communication terminal 100 (Step S18). As a result, the connection between the environment information measuring device 200 and the communication terminal 100 ends. Then, the environment information measuring device 200 performs advertise again.

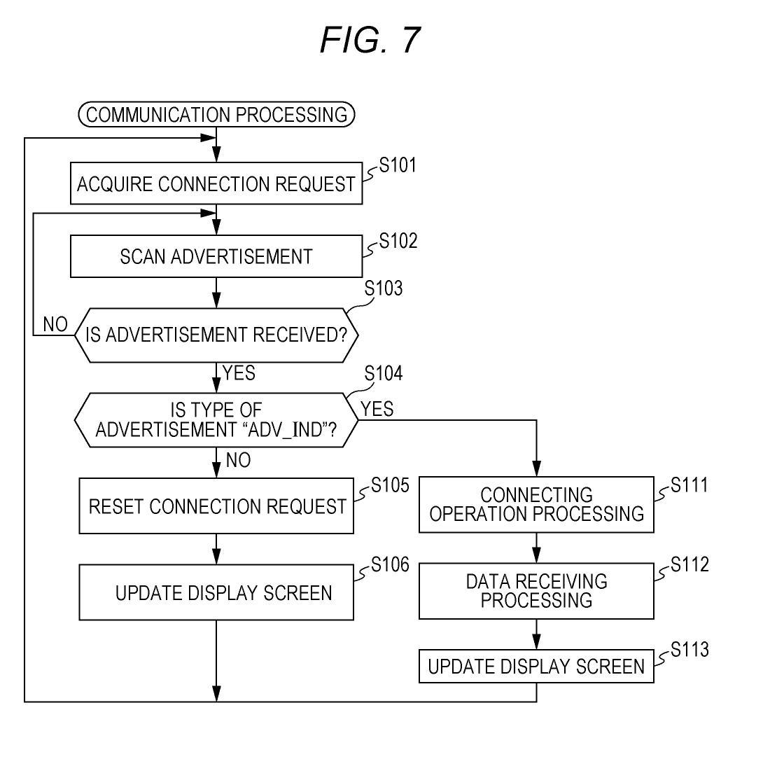

Next, the operation of the communication terminal 100 according to the present embodiment will be described with reference to FIG. 7. FIG. 7 is a flowchart showing an example of communication processing executed by the control unit 102 of the communication terminal 100 according to the present embodiment. This communication processing is performed by the control unit 102 which reads and executes the program preliminarily stored in the ROM 104.

The control unit 102 of the communication terminal 100 starts the communication processing shown in FIG. 7, for example, after the application for measuring environment information is launched.

First, the connection request acquiring unit 151 acquires, for example, the operation on the touch panel 130 performed by the user to measure the environment information, as a connection request with the environment information measuring device 200 (Step S101).

The receiving unit 152 executes the receiving operation processing to receive the advertisement. In the receiving operation processing, the receiving unit 152 scans the advertisement (Step S102), and determines whether the advertisement transmitted by the environment information measuring device 200 has been received (Step S103). When it is determined in Step S103 that the advertisement has not been received (Step S103; No), after the polling cycle passes, the flow returns to Step S102 and the receiving unit 152 scans the advertisement again.

When it is determined in Step S103 that the advertisement has been received (Step S103; Yes), the determining unit 153 determines whether the type of the advertisement received is “ADV_IND” (Step S104). In Step S104, the determining unit 153 determines that the type of the advertisement is “ADV_IND” when the value set in the type setting region in the header part of the advertisement received is “0x00”, and determines that the type of the advertisement is not “ADV_IND”, that is, the type of the advertisement is “ADV_NONCONN_IND” when the value set in the type setting region is “0x03”.

When it is determined in Step S104 that the type of the advertisement is not “ADV_IND” (Step S104; No), the connection control unit 154 resets the connection request and does not execute the connecting operation processing with the environment information measuring device 200 (Step S105). Thereafter, the control unit 102 updates a display screen of the display unit 128 (Step S106). In Step S106, the control unit 102 displays, for example, the WBGT value “less than 25° C.” and the image such as “attention” on the display screen of the display unit 128. When the WBGT value “less than 25° C.” and the image such as “attention” have already been displayed on the display screen of the display unit 128, the image such as “no change” may be further displayed.

When it is determined in Step S104 that the type of the advertisement is “ADV_IND” (Step S104; Yes), the connection control unit 154 executes the connecting operation processing with the environment information measuring device 200 (Step S111). In Step S111, the connection control unit 154 transmits the connection request signal to the environment information measuring device 200 as described above.

After executing the processing of Step S111, the control unit 102 executes data receiving processing, and receives data from the environment information measuring device 200 (Step S112). Then, the control unit 102 updates the display screen of the display unit 128 based on the data received (Step S113). In Step S113, the control unit 102 displays, on the display screen of the display unit 128, the WBGT value “25° C.”, the image such as “warning”, and measured values such as the temperature and the relative humidity as shown in FIG. 1.

After executing the processing of Step S106 or Step S113, the flow returns to Step S101, and the control unit 102 executes repeatedly the above processing. The communication processing ends, for example, when the user operates the touch panel 130 to end the application for measuring environment information.

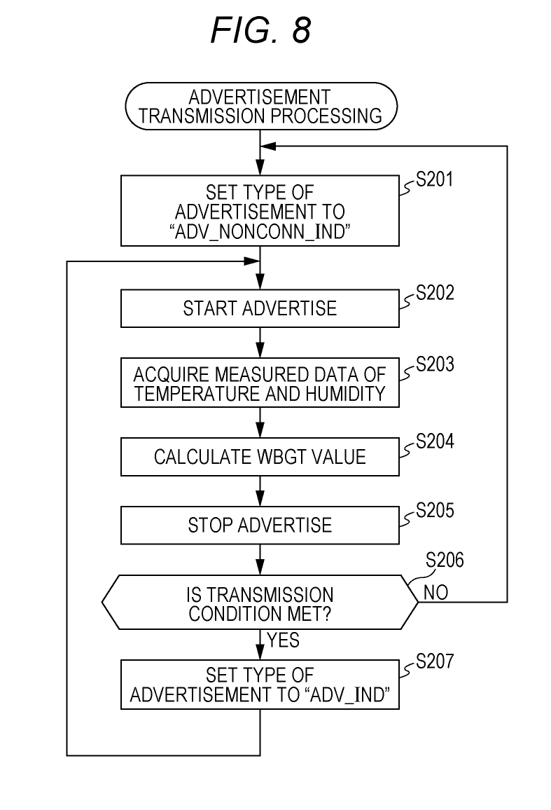

Next, the operation of the environment information measuring device 200 according to the present embodiment will be described with reference to FIG. 8. FIG. 8 is a flowchart showing an example of advertisement transmission processing executed by the control unit 202 of the environment information measuring device 200 according to the present embodiment. This advertisement transmission processing is performed by the control unit 202 which reads and executes the program preliminarily stored in the ROM 204.

The control unit 202 of the environment information measuring device 200 starts the advertisement transmission processing shown in FIG. 8, for example, after the power becomes ON by the operation of the user on the operation unit 220.

First, the advertisement type changing unit 253 sets the type of the advertisement to “ADV_NONCONN_IND” as an initial setting (Step S201).

Next, the advertisement transmitting unit 250 starts advertise, i.e., periodically transmitting the advertisement of the set type to the communication terminal 100 (Step S202). When the processing of Step S202 is executed after the processing of Step S201 is executed, the advertisement transmitting unit 250 transmits the advertisement of the type “ADV_NONCONN_IND” to the communication terminal 100.

Next, the data acquiring unit 251 acquires data of current temperature from the temperature sensor 230 and data of current relative humidity from the humidity sensor 240 (Step S203).

Then the determining unit 252 calculates the WBGT value from the data of the temperature and the relative humidity acquired by the data acquiring unit 251 (Step S204). After the processing of Step S204 is executed, the advertisement transmitting unit 250 stops advertise (Step S205). Thereafter, the determining unit 252 determines whether the WBGT value calculated is 25° C. or more, that is, whether the WBGT value meets the transmission condition (Step S206).

When it is determined in Step S206 that the transmission condition is met (Step S206; Yes), the advertisement type changing unit 253 sets the type of the advertisement to “ADV_IND” (Step S207). In Step S207, since the advertisement transmitting unit 250 has been transmitting the advertisement of the type “ADV_NONCONN_IND” until the last minute, the advertisement type changing unit 253 changes the type of the advertisement from the type “ADV_NONCONN_IND” to the type “ADV_IND”. When the advertisement transmitting unit 250 has been transmitting the advertisement of the type “ADV_IND” until the last minute, the advertisement type changing unit 253 keeps the type of the advertisement at the type “ADV_IND”.

After the processing of Step S207 is executed, the flow returns to Step S202, and the advertisement transmitting unit 250 starts advertise again (Step S202). Since the processing of Step S202 is executed after the processing of Step S207 is executed, the advertisement transmitting unit 250 transmits the advertisement of the type “ADV_IND” to the communication terminal 100.

When it is determined in Step S206 that the transmission condition is not met (Step S206; No), the flow returns to Step S201, and the advertisement type changing unit 253 sets the type of the advertisement to “ADV_NONCONN_IND” (Step S201). In Step S201, since the advertisement transmitting unit 250 has been transmitting the advertisement of the type “ADV_NONCONN_IND” until the last minute, the advertisement type changing unit 253 keeps the type of the advertisement at the type “ADV_NONCONN_IND”. When the advertisement transmitting unit 250 has been transmitting the advertisement of the type “ADV_IND” until the last minute, the advertisement type changing unit 253 changes the type of the advertisement from the type “ADV_IND” to the type “ADV_NONCONN_IND”.

By repeatedly executing the above processing in this manner, the advertisement of type “ADV_IND” or the type “ADV_NONCONN_IND” is transmitted.

The advertisement transmission processing is temporarily cut off, for example, when the transmission and reception of the data with the communication terminal 100 are being performed (when the environment information measuring device 200 and the communication terminal 100 are connected). The advertisement transmission processing ends, for example, when the power becomes OFF by the operation of the user on the operation unit 220.

As described above, according to the environment information measuring device 200 of the above embodiment, the type of the advertisement is changed to the type “ADV_IND” or the type “ADV_NONCONN_IND”, for example, based on a determination result as to whether the transmission condition is met, the transmission condition representing whether the data transmission of Step S206 is required. Then, the advertisement of the type after change is transmitted to the communication terminal 100. The communication terminal 100 controls the connection with the environment information measuring device 200 based on the type of the advertisement received. The environment information measuring device 200 does not transmit the data such as the temperature, the relative humidity, and the WBGT value to the communication terminal 100, unless the environment information measuring device 200 receives the connection request signal from the communication terminal 100. Therefore, wasteful power consumption can be suppressed.

According to the environment information measuring device 200 of the above embodiment, for example, when the transmission condition is not met, the transmission condition representing whether the data transmission is required, the type of the advertisement is changed to the type “ADV_NONCONN_IND”, and the advertisement of the type “ADV_NONCONN_IND” is transmitted to the communication terminal 100. When the transmission condition is met, the transmission condition representing whether the data transmission is required, the type of the advertisement is changed to the type “ADV_IND”, and the advertisement of the type “ADV_IND” is transmitted to the communication terminal 100. The communication terminal 100 does not execute the connecting operation processing, which transmits the connection request signal to the environment information measuring device 200, when the type of the advertisement received is “ADV_NONCONN_IND”. The environment information measuring device 200 does not transmit the data such as the temperature, the relative humidity, and the WBGT value to the communication terminal 100, unless the environment information measuring device 200 receives the connection request signal from the communication terminal 100. Therefore, wasteful power consumption can be suppressed.

According to the environment information measuring device 200 of the above embodiment, the advertisement is periodically transmitted to the communication terminal 100 as shown in FIG. 6. Therefore, the advertisement of the type “ADV_IND” and the advertisement of the type “ADV_NONCONN_IND” can be switched and transmitted in a suitable manner.

According to the wireless communication system 1 of the above embodiment, for example, when the type of the advertisement transmitted by the environment information measuring device 200 is “ADV_IND” as shown in FIG. 6, the communication terminal 100 executes the connecting operation processing with the environment information measuring device 200 and transmits/receives the data to/from the environment information measuring device 200. On the other hand, when the type of the advertisement transmitted by the environment information measuring device 200 is “ADV_NONCONN_IND”, the communication terminal 100 does not execute the connecting operation processing with the environment information measuring device 200. In this case, the communication terminal 100 does not transmit/receive the data to/from the environment information measuring device 200. In this way, when there is no data to be transmitted to the environment information measuring device 200, the transmission and reception of the data are not performed. Therefore, the wasteful power consumption can be suppressed.

This invention is not limited to the above embodiment, and various modifications and applications can be made.

### Modified Example

In the above embodiment, the determination as to whether the transmission condition is met, the transmission condition representing whether the data transmission is required, is the determination as to whether the WBGT value calculated is equal to or more than the reference value (25° C.). However, the determination as to whether the transmission condition is met is not limited to the one described above. For example, the determination as to whether the transmission condition is met, the transmission condition representing whether the data transmission is required, may be the determination as to whether the classification to which the WBGT value calculated this time belongs is the same as the classification to which the WBGT value calculated at the time of the previous data transmission belongs. In this case, the determining unit 252 determines that the data transmission to the communication terminal 100 is required, when the classification to which the WBGT value calculated this time belongs differs from the classification to which the WBGT value calculated at the time of the previous data transmission belongs. In addition, the determining unit 252 determines that the data transmission to the communication terminal 100 is not required, when the classification to which the WBGT value calculated this time belongs is the same as the classification to which the WBGT value calculated at the time of the previous data transmission belongs.

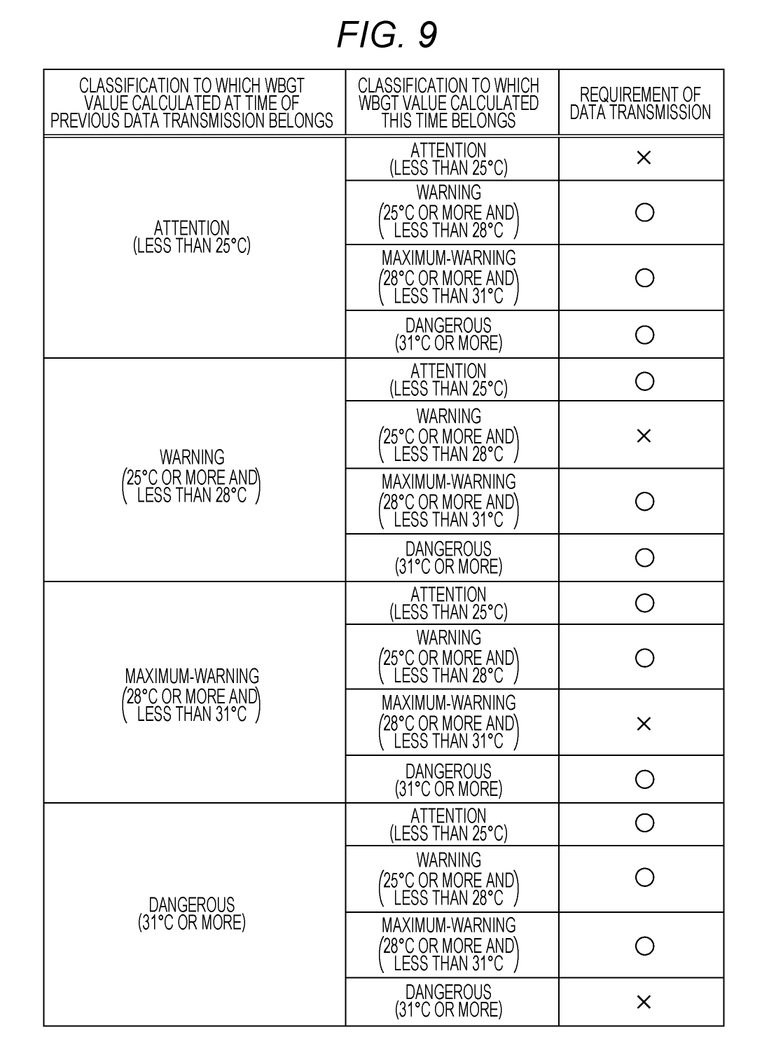

FIG. 9 is a diagram showing an example of the transmission condition representing whether the data transmission is required.

As shown in FIG. 9, the determining unit 252 determines that the data transmission to the communication terminal 100 is not required (shown by “x” in FIG. 9), for example, when the classification to which the WBGT value calculated at the time of the previous data transmission belongs is “attention” (WBGT value is less than 25° C.) and the classification to which the WBGT value calculated this time belongs is “attention” (WBGT value is less than 25° C.). The determining unit 252 determines that the data transmission to the communication terminal 100 is required (shown by “0” in FIG. 9), when the classification to which the WBGT value calculated at the time of the previous data transmission belongs is “attention” (WBGT value is less than 25° C.) and the classification to which the WBGT value calculated this time belongs is “warning” (WBGT value is 25° C. or more and less than 28° C.), “maximum-warning” (WBGT value is 28° C. or more and less than 31° C.), or “dangerous” (WBGT value is 31° C. or more).

The determining unit 252 also determines in the same manner as described above for the case where the classification to which the WBGT value calculated at the time of the previous data transmission belongs is “warning” (WBGT value is 25° C. or more and less than 28° C.), “maximum-warning” (WBGT value is 28° C. or more and less than 31° C.), or “dangerous” (WBGT value is 31° C. or more).

The WBGT value calculated at the time of the previous data transmission does not exist, immediately after the power of the environment information measuring device 200 becomes ON, since the data has not been transmitted to the communication terminal 100. Therefore, the classification to which the WBGT value calculated this time belongs preferably differs from the classification to which the WBGT value calculated at the time of the previous data transmission belongs, and it is preferably determined that the transmission condition is met.

Under such a transmission condition, based on a determination result as to whether the transmission condition is met, the environment information measuring device 200 changes the type of the advertisement to the type “ADV_IND” or the type “ADV_NONCONN_IND”, and the advertisement of the type after change is transmitted to the communication terminal 100. The communication terminal 100 controls the connection with the environment information measuring device 200 based on the type of the advertisement received. Therefore, wasteful power consumption can be suppressed.

Although the embodiment and the modified example thereof have been described above, the invention is not limited to the above embodiment and the modified example thereof.

In the above embodiment, the wireless communication system 1 is configured by the communication terminal 100 as a central and the environment information measuring device 200 as a peripheral. However, the wireless communication system 1 is not limited to the one configured by the communication terminal 100 and the environment information measuring device 200. For example, an alarm device including a sensor which detects hacking may be considered to be the peripheral, and the wireless communication system 1 may be configured by this alarm device and the communication terminal 100. In this case, the type of the advertisement is changed to the type “ADV_IND”, for example, when the alarm device detects the hacking. In addition, for example, a pollen measuring device including a sensor which detects an amount of pollen may be considered to be the peripheral, and the wireless communication system 1 may be configured by this pollen measuring device and the communication terminal 100. In this case, the type of the advertisement is changed to the type “ADV_IND”, for example, when the amount of pollen measured by the pollen measuring device exceeds a reference value.

In the above embodiment, although the smartphone is applied as the central, the wireless communication device being the central is not limited to the smartphone. For example, a wristwatch capable of performing wireless communication based on the BLE may be applied as the central, and the smartphone, the mobile phone, etc. having a mail receiving function may be applied as a peripheral. In this case, the type of the advertisement may be changed to the type “ADV_IND” when the smartphone, etc. receives a mail. In such a configuration, it is possible to display reception of a mail on the wristwatch.

In the above embodiment, the wireless communication system 1 is configured by one central (communication terminal 100) and one peripheral (environment information measuring device 200) as shown in FIG. 1. However, the wireless communication system 1 may be configured by one or a plurality of centrals and one or a plurality of peripherals. When there is a plurality of peripherals, the central may sequentially receive the advertisement from the peripherals. When there is a plurality of centrals, the peripheral may make a connection with the central which has transmitted the connection request signal received and start the transmission of the data to the central connected.

In the above embodiment, although one control unit has been described, the present invention is not limited thereto, and the processing may be performed by a plurality of control units.

In addition, the communication terminal 100 and the environment information measuring device 200 according to the embodiment of the present invention can be realized using a normal computer system without using a dedicated device. For example, the function of the communication terminal 100 and the function of the environment information measuring device 200 may be realized by executing a program by the computer. The program to realize the function of the communication terminal 100 and the function of the environment information measuring device 200 may be stored in a computer-readable recording medium such as a universal serial bus (USB) memory, a secure digital (SD) memory card, a compact disc read only memory (CD-ROM), a digital versatile disc (DVD), a Blu-ray (registered trademark) disk (BD), or a hard disk drive (HDD), or may be downloaded to the computer via a network.

Although the preferred embodiment of the present invention has been described above, the present invention is not limited to the specific embodiment, and includes the invention described in the claims and equivalents thereof.

What is claimed is:

1. A wireless communication device which performs wireless communication with another wireless communication device, comprising:
a communication unit configured to:
transmit, to the another wireless communication device, identification information of any type among identification information of a plurality of types;
acquire data from the another communication device;
a control unit configured to:
determine whether the data meets a transmission condition representing whether data transmission to the another wireless communication device is required; and
change the type of the identification information transmitted by the communication unit based on a determination result.

2. The wireless communication device according to claim 1,
wherein the communication unit receives a connection request signal transmitted based on the identification information by the another wireless communication device, and transmits the data to the another wireless communication device according to the connection request signal.

3. The wireless communication device according to claim 1,
wherein the communication unit transmits, to the another wireless communication device, either identification information of a first type indicating that the connection request signal is receivable or identification information of a second type indicating that the connection request signal is not receivable, and
the control unit changes the type of the identification information to the first type when it is determined that the transmission condition is met, and changes the type of the identification information to the second type when it is determined that the transmission condition is not met.

4. The wireless communication device according to claim 1,
wherein the communication unit periodically transmits the identification information to the another wireless communication device.

5. The wireless communication device according to claim 1,
wherein the control unit changes the type of the identification information by setting a type region of the identification information.

6. The wireless communication device according to claim 1, comprising a plurality of control units.

7. A wireless communication method of performing wireless communication with another wireless communication device, comprising:
an identification information transmitting step of transmitting, to the another wireless communication device, identification information of any type among identification information of a plurality of types;
a data acquiring step of acquiring data;
a determining step of determining whether the data acquired at the data acquiring step meets a transmission condition, the transmission condition representing whether data transmission to the another wireless communication device is required; and
an identification information type changing step of changing the type of the identification information transmitted at the identification information transmitting step, based on a determination result of the determining step.

8. A non-transitory computer-readable medium for causing a computer to execute:
identification information transmitting processing to transmit, to another wireless communication device, identification information of any type among identification information of a plurality of types;
data acquiring processing to acquire data;
determining processing to determine whether the data meets a transmission condition, the transmission condition representing whether data transmission to the another wireless communication device is required; and
identification information type changing processing to change the type of the identification information transmitted by the identification information transmitting processing, based on a determination result of the determining processing.

9. A peripheral which performs wireless communication with a central based on Bluetooth (registered trademark) low energy, comprising: a communication unit configured to transmit, to the central, an advertisement of any type among advertisements of a plurality of types and to acquire data; and
a control unit configured to determine whether the data meets a transmission condition, the transmission condition representing whether data transmission to the central is required, and to change the type of the advertisement transmitted by the communication unit, based on a determination result.
